(19) United States
(12) Patent Application Publication
(10) Pub. No.: US 2004/0002238 A1
(43) Pub. Date: Jan. 1, 2004

(54) Relay box for vehicle

(76) Inventor: Hyun-Sik Kim, Seoul (KR)

Correspondence Address: Pennie & Edmonds, LLP, 3300 Hillview Avenue, Palo Alto, CA, 94304, US

(21) Appl. No.: 10/331,872

(22) Filed: Dec. 30, 2002

(30) Foreign Application Priority Data
Jun. 26, 2002 (KR) 2002-0035978

(51) Int. Cl. H01R 12/00

(52) U.S. Cl. 439/76.2

(57) ABSTRACT

A relay box for a vehicle that reduces the heat given to elements in the relay box to improve the durability of the elements. The relay box includes a plurality of relay connections, the relay connections being disposed in a non-parallel fashion at predetermined intervals; and relays, each mounted to the relay connections to form electrical circuits corresponding to electrical components of the vehicle.

### FIELD OF THE INVENTION

The present invention relates to a relay box for a vehicle, and more particularly, to a relay box configured to dissipate heat more efficiently.

### BACKGROUND OF THE INVENTION

Relays and fuses used in the electrical system of a vehicle are typically gathered in a case, referred to as a relay box. This box is mounted in an engine compartment. Reducing the temperatures experienced by the elements in the relay box (i.e., relays and fuses) is extremely important because the elements may be damaged or experience a reduction in their lifespan if overheated for a significant time. Since the elements in the relay box play a vital role in vehicle safety, if these elements malfunction without warning the safe operation of the vehicle could be compromised.

If the surface temperature of each relay is measured at various currents generated currents by the application of different voltages, it becomes apparent that the surface temperatures for each relay are different. This indicates that power loss within a single relay box does not occur uniformly. Furthermore, this difference in surface temperatures makes it clear that the relays generate different amounts of heat. These surface temperatures may be theoretically calculated or experimentally measured.

With reference to FIGS. 1 and 2, the heat distribution in a relay box 110 will be described below. The codes in the format of ‘T-xxxX’ in the legend of FIG. 2 will first be described. With the code T-z21C, for example, z2 is a temperature of a surface z2 of a first relay 120 obtained by model forecasting, C indicates a value obtained through calculations, and T indicates a value obtained through experimentation. Since the relay box 110 is designed symmetrically about center lines (i.e., a pair of perpendicular lines passing through a center of the relay box 110), only surface temperatures of first, second, and third relays 120, 121, and 122 are shown.

As is clear from FIG. 2, the surface temperature of the third relay 122 is higher than the surface temperatures of the other relays, that is, of the first and second relays 120 and 121. The main reasons for this discrepancy are due to a joint temperature increase effect and a gap degree. The joint temperature increase effect refers to the increase in temperature caused by the generation of heat between surfaces of adjacent relays, and the gap degree refers to the gaps between the relays. As shown in FIG. 1, the third relay 122 is surrounded by more relays than relays 120 and 121 are.

If the distribution in the generation of heat by the relays were precisely known, it would be possible to modify the joint temperature increase effect and the gap degree to control heat generation. This would allow for a reduction in power loss and relay damage caused by excessive heating of the relays.

Present designs for relay boxes are such that each relay is oriented in the same direction. As a result, the hot surfaces of the relays are adjacent to one another, thereby resulting in greater heat transfer and retention. Therefore, there is a need to reduce the heat transferred and retained by relays or fuses.

### SUMMARY OF THE INVENTION

The present invention provides a relay box for a vehicle that reduces the temperature of the elements in the relay box to improve the durability of the elements. In a preferred embodiment, the present invention includes a plurality of relay connections, the relay connections being disposed in a non-parallel fashion at predetermined intervals; and relays, each mounted to the relay connections as part of electrical circuits within the vehicle.

In a preferred embodiment, the relay connections are formed such that surfaces of the relays mounted to the relay connections are at a substantial distance from one another. In another preferred embodiment, the relay connections are oriented corner to corner. In another preferred embodiment, the present invention further includes fuse connections provided in spaces in the relay box between the relay connections. It is preferable that a heat escape pathway is defined by the combination of the relay connections and the fuse connections.

An additional preferred embodiment of the relay box comprises an arrangement of relay connections, where adjacent relay connections are moved with respect to each other so that radiate energy from an area of one relay connection would not be perpendicularly incident upon an outline of a relay associated with an adjacent relay connection.

A further preferred embodiment of the relay box includes at least one fuse connection located between non-adjacent relay connections.

Another preferred embodiment comprises a plurality of relays inserted into the plurality of relay connections. In this embodiment the relays are a source of radiant energy; the arrangement of the relay connections orients the relays so that radiant energy from one relay is not perpendicularly incident upon an adjacent relay; and the plurality of relays is maintained at a lower operating temperature by said arrangement. Preferably, adjacent relay connections are also rotated with respect to each other. And preferably, the rotation causes a cooler side of one relay to be nearer an adjacent relay.

In an additional preferred embodiment, a surface temperature of a side of each said relay is measured during operation and at least one of the relay with a relatively higher side surface temperature is oriented in the relay box so that the relatively higher side surface is directed past adjacent relays. Finally, in an additional preferred embodiment at least one heat escape pathway is defined between a pair of adjacent relay connections.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of the arrangement of relays in a conventional relay box;

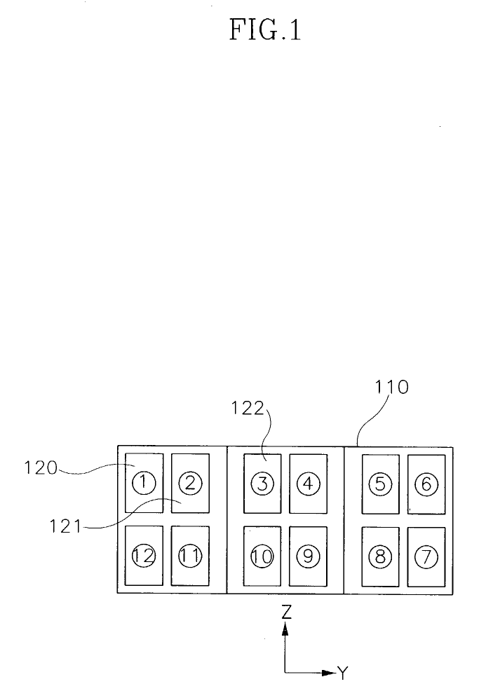

FIG. 2 is a graph showing changes in surface temperatures of relays as a function of current in the conventional relay box for vehicles;

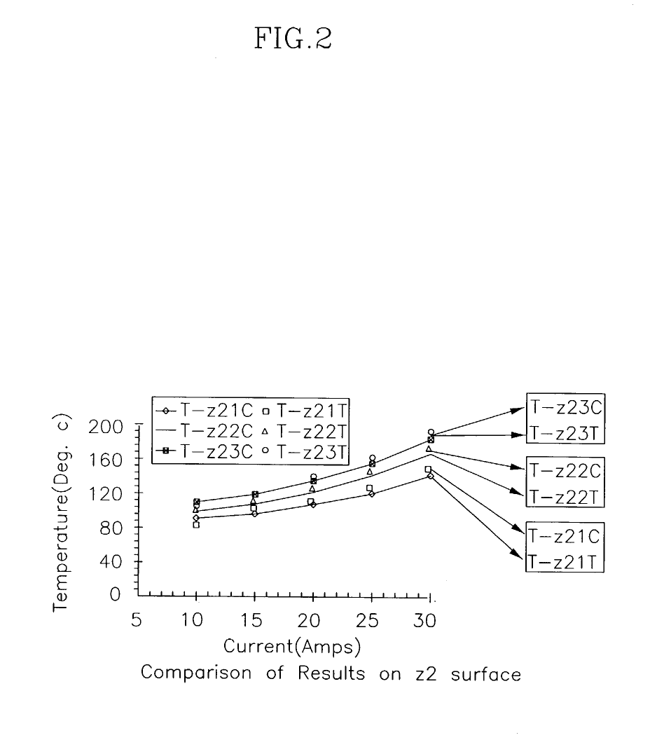

FIG. 3 is a plan view of an arrangement of relays and fuses in a relay box according to a preferred embodiment of the present invention; and

FIG. 4 is a plan view showing an arrangement of relay connection holes formed by the relay connections of FIG. 3.

Like numerals refer to similar elements throughout the several drawings.

### DETAILED DESCRIPTION OF THE PREFERRED EMBODIMENTS

Although there are variations depending on car type, in most present-day relay boxes, the relays and fuses are separately provided with the contact surfaces of the relays being in close proximity and the relay pins being provided in the same orientation. A significant amount of heat is therefore retained by these elements. The relays are mounted close to each other to minimize the space used by the relay box in the engine compartment. There is therefore the need of a design in which the relay surfaces are distanced as much as possible while minimizing the size of the relay box so as to limit the room occupied by the relay box in the engine compartment.

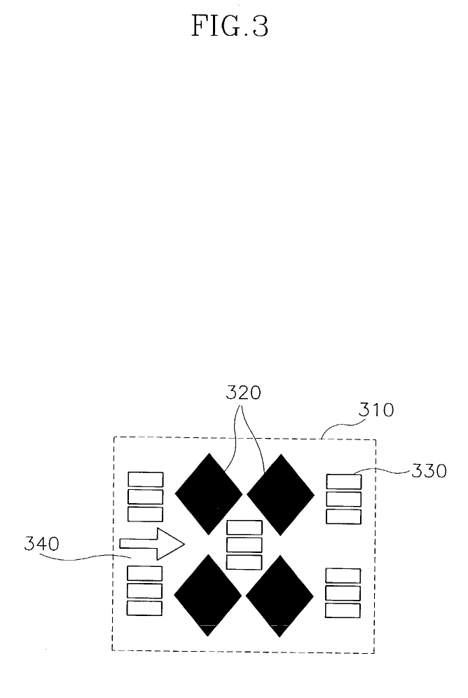

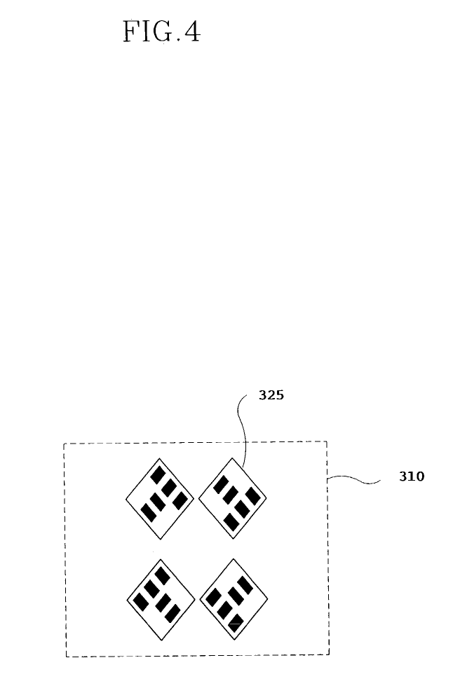

In a preferred embodiment of the present invention, as shown in FIGS. 3 and 4, the relay box 310 includes a plurality of box walls with a bottom wall supporting relay connections 325. Relays 320, mounted on the relay connections and fuses mounted on fuse connections 330 define a heat escape pathway 340 as explained below.

The relay connectors 325 are arranged so the surfaces of the relays 320 fixed to the relay connections are provided at a substantial distance from one another and preferably such that flat sides of the relays are not adjacent. The relay connections 325 are more preferably formed so the fixing of the relays thereto results in the relays being disposed corner to corner. The relays 320 are coupled to the plurality of the relay connections 325 and the electrical circuits corresponding to the electrical components of the vehicle.

Fuse connections 330 are provided at areas in the relay box 310 where the relays 320 are not mounted, including among the relays. Although fuses also generate heat, the significant difference between the heights of the relays and fuses, coupled with the configuration of the relays and fuses, allows the reduction of heat in both relays and fuses, compared to the conventional.

The heat escape pathway 340 is defined by the combination of the relays 320 and the fuse connections 330. As indicated, with the relay box 310 the surfaces of the relays are distanced to reduce the heat transferred and retained by the relays and the heat escape pathway 340 is provided to allow for dissipation of heat, thereby reducing the relay and fuse temperature. Additional heat reduction is obtained because radiant energy from one relay is not perpendicularly incident upon an adjacent relay, resulting in less energy being transferred.

In a conventional relay box, the relays are typically mounted according to relay size. But this creates the possibility that the relays that generate most of the heat will be next to each other in the relay box. Accordingly, a preferred embodiment of the present invention avoids the configuration in which the relays are mounted tightly grouped together with their connections oriented in the same direction.

A relay can usually withstand temperatures of 140° C. for 5000 hours, but it is able to withstand temperatures of approximately 170° C. for only a few hours. This ability may decrease with the excessive current that may flow as a result of defective elements or faulty wiring. Accordingly, to avoid damage to the relays caused by high temperatures, it is necessary to determine the maximum surface temperature of the relays and to group them so that the relays with greater surface temperature are surrounded by relays of lesser surface temperature.

The relay box 310 for vehicles according to a preferred embodiment of the present invention reduces the transfer and retention of heat by the relays to improve the durability of the elements in the relay box 310. Thus, the life of the relays and the life of the fuses are increased, and the premature blowing of the fuses is prevented, thereby improving safety and driver convenience.

In the above, preferred embodiments of the invention have been shown and described to illustrate the invention. As will be realized by one of ordinary skill in the art, the invention is capable of modification in various obvious respects, all without departing from the spirit of the invention. Accordingly, the drawings and description are to be regarded as illustrative in nature, and not restrictive. It should be clearly understood that the many variations and/or modifications of the basic inventive concepts herein taught which will be apparent to one of ordinary skill in the art fall within the spirit and scope of the present invention, as defined in the appended claims.

What is claimed is:

1. A relay box for a vehicle, comprising:
a plurality of relay connections, the relay connections being disposed in a non-parallel fashion at predetermined intervals; and
relays, each mounted to the relay connections as part of electrical circuits within the vehicle.

2. The relay box of claim 1, wherein the relay connections are formed such that surfaces of the relays mounted to the relay connections are at a substantial distance from one another.

3. The relay box of claim 1, wherein the relay connections are oriented corner to corner.

4. The relay box of claim 1, further comprising fuse connections provided in spaces in the relay box between the relay connections.

5. The relay box of claim 4, wherein a heat escape pathway is defined by the combination of the relay connections and the fuse connections.

6. A relay box, comprising an arrangement of relay connections, wherein adjacent relay connections are moved with respect to each other so that radiant energy from an area of one said relay connection is not perpendicularly incident upon a relay associated with an adjacent relay connection.

7. The relay box of claim 6, wherein at least one fuse connection is located between non-adjacent relay connections.

8. The relay box of claim 6, further comprising a plurality of relays inserted into the plurality of relay connections, and wherein:
said relays are a source of radiant energy;
radiant energy from one said relay is not perpendicularly incident upon an adjacent relay; and
said plurality of relays is maintained at a lower operating temperature by said arrangement.

9. The relay box of claim 8, wherein adjacent relay connections are rotated with respect to each other.

10. The relay box of claim 9, wherein said rotation causes a cooler side of one said relay to be nearer an adjacent relay.

11. The relay box of claim 8, wherein at least one heat escape pathway is defined between a pair of adjacent relay connections.

12. The relay box of claim 8, wherein a surface temperature of each said relay is measured during operation and at least one relay with a relatively higher surface temperature is placed in the relay box among relays of relatively lower surface temperature.

13. The relay box of claim 8, wherein a surface temperature of a side of each said relay is measured during operation and at least one said relay with a relatively higher side surface temperature is oriented in the relay box so that the relatively higher side surface is directed past adjacent relays.

14. A relay box for a vehicle, comprising:
a least one box wall; and
a plurality of relay connections mounted on said box wall, said connections Arranged such that relays mounted in the box have no adjacent flat sides.

15. The relay box of claim 14, further comprising fuse connections mounted on the box wall interspersed among the relay connections.

16. The relay box of claim 14, wherein the relay connections are arranged to dispose relays mounted thereon at least approximately corner to corner.

17. The relay box of claim 14, wherein the relay connections are further arranged such that relays of greater surface temperature are surrounded by relays of lesser surface temperature.
